(19) United States
(12) Patent Application Publication
(10) Pub. No.: US 2013/0247085 A1
(43) Pub. Date: Sep. 19, 2013

(54) METHOD FOR GENERATING VIDEO MARKUP DATA ON THE BASIS OF VIDEO FINGERPRINT INFORMATION, AND METHOD AND SYSTEM FOR PROVIDING INFORMATION USING SAME

(71) Applicants: Jaehyung Lee, Gyeonggi-do (KR); Kil-Youn Kim, Seoul (KR)

(72) Inventors: Jaehyung Lee, Gyeonggi-do (KR); Kil-Youn Kim, Seoul (KR)

(73) Assignee: ENSWERS CO., LTD., Seoul (KR)

(21) Appl. No.: 13/988,683

(22) PCT Filed: Oct. 10, 2011
(86) PCT No.: PCT/KR2011/007476

§ 371 Date: May 21, 2013

(30) Foreign Application Priority Data
Nov. 22, 2010 (KR) 10-2010-0115977

(51) Int. Cl. H04N 21/44

(52) U.S. Cl. CPC H04N 21/44008
USPC 725/19

(57) ABSTRACT

The present invention relates to a method for generating video markup data on the basis of video fingerprint information, and to a method and system for providing information using same; and more particularly, to a method and system for conveniently and efficiently providing a variety of pieces of information, such as object-related advertising information, on the basis of video markup data which are generated in consideration of object information relating to objects in a video and of the fingerprint information of the video.

### TECHNICAL FIELD

The present invention relates generally to a method of generating video markup data based on video fingerprint information and a method and system for providing information using the method of generating video markup data based on video fingerprint information and, more particularly, to a method and system that can generate video markup data in consideration of both object information about objects included in a video and the fingerprint information of the video, and can conveniently and efficiently provide various types of information, such as advertisement information associated with the objects, to users based on the video markup data.

### BACKGROUND ART

With the development of multimedia technology, many pieces of video content produced by various copyright holders are being provided to users over the Internet at the present time. Further, the types of content players which were limited to only television (TV) and radio in the past, have recently grown in number to include devices such as a Personal Computer (PC), an MPEG Audio Layer 3 (MP3) player, a Netbook, a Portable Media Player (PMP), and a smart phone, and users can enjoy various pieces of video content using those devices, even while moving. The number of users who enjoy such video content is on an upward trend, but methods of viewing video content have not greatly changed, and so most users are still playing video content unidirectionally. In order to overcome this disadvantage, in an MPEG 7 standard or the like, there have been made efforts to indicate an object or the like on each frame of a video and contain the semantic information thereof, but methods of attaching such semantic information onto video content distributed over various paths and formats and providing an experience in bidirectionally viewing video content based on the semantic information have not yet been presented.

Meanwhile, unlike methods of providing advertisements based on text, which are widely used and yield a large profit, advertisements attached to video content provided over the Internet have not yet been recognized as profit sources. Methods of inserting advertisements into video content include methods, such as preroll, postroll, midroll, overlay, and banner, but those video advertisements are disadvantageous in that, unlike text advertisements, it is difficult to accurately determine what the users want, and to show advertisements while the users are viewing video content without interfering with their viewing experience. As a result, methods of providing advertisements based on video content are lower than those of text advertisements in spite of their high cost prices, and the number of advertisers is not large yet.

Further, methods of providing information about objects included in a video during the viewing of the video are limited in that information must be separately generated for each video, and such generated information is restrictively used only for the video that it is based on, thus making it impossible to use the generated information for an edited version, a corrected version, or the like of the video.

### DISCLOSURE

### Technical Problem

Accordingly, the present invention has been made keeping in mind the above problems, and an object of the present invention is to provide a method and apparatus that can generate video markup data from both the fingerprint information of a video and object information describing various meanings of landscapes, objects, and persons included in the video.

Another object of the present invention is to provide a method and system that cause additional information, such as advertisement information, to be included in object information included in the above video markup data, thus efficiently providing additional information, such as advertisement information set in correspondence with each object of video data, to users.

A further object of the present invention to provide a method and system that can generate video markup data, including unique fingerprint information, for video data, thus conveniently and efficiently providing the same object information or advertisement information even for various types of derivative video data obtained by processing or editing the corresponding video data.

Yet another object of the present invention is to provide a method and system that can provide information about a specific area together with a link when a user expresses his or her interest in the specific area using a touch action based on the manipulation of a mouse on the specific area at a specific moment while the user is playing and viewing video data, and can accurately provide, in real time, ancillary information, such as advertisement information related to such an area.

### Technical Solution

In order to accomplish the above objects, the present invention provides a method of generating video markup data based on video fingerprint information, including a first step of generating, for one or more sections of video data to be a target for which video markup data is to be generated, object information about objects included in each of the sections; a second step of extracting, for the sections, partial fingerprint information related to each of the sections; and a third step of generating video markup data about the video data so that the object information and the partial fingerprint information are included in each section.

In this case, the object information at the first step may include at least one of fade-in in time information and fade-out time information of each object, and the partial fingerprint information at the second step may be extracted based on at least one of the fade-in time information and the fade-out time information of the object.

Further, the object information at the first step may include object space information indicative of relative location information and size information on display means when the corresponding video data is played, object feature information indicative of features of each object, and advertisement information set in correspondence with each object.

In accordance with another aspect of the present invention, the present invention provides a method of generating video markup data based on video fingerprint information, including a first step of extracting, for all sections of video data, entire fingerprint information; a second step of generating, for one or more sections of video data to be a target for which video markup data is to be generated, section identification information for each of the sections and object information about objects included in each section; a third step of including individual pieces of section identification information in the entire fingerprint information so that the pieces of section identification information are identifiable; and a fourth step of generating video markup data about the video data so that the video markup data includes the entire fingerprint information, the section identification for each section, and the object information for each section.

In this case, the object information at the second step may include at least one of fade-in time information and fade-out time information of each object.

Further, the object information at the second step may include object space information indicative of relative location information and size information on display means when the corresponding video data is played, object feature information indicative of features of each object, and advertisement information set in correspondence with each object.

In accordance with a further aspect of the present invention, the present invention provides an information provision method using video markup data based on video fingerprint information, the information provision method providing information while providing a video service to a client terminal, in an information provision system provided with a video markup database having video markup data generated by the above method and connected to the client terminal over a network, the information provision method including a first step of receiving an object information request signal from the client terminal while providing a video playing service to the client terminal; a second step of querying the video markup database about object information in response to the object information request signal; and a third step of transmitting the queried object information to the client terminal.

In this case, the object information request signal at the first step may be generated by a user selecting an object appearing on a video being played on a screen of a display device of the client terminal using an input device.

Further, the object information request signal may include information about a location selected by the user on the video being played on the screen of the display device of the client terminal, and the second step may be configured to query about the object information based on the location information included in the object information request signal.

Furthermore, the object information request signal may further include identification information of the video being played on the display device of the client terminal, and the second step may be configured to query about the object information based on the identification information of the video and the location information included in the object information request signal.

Furthermore, the identification information of the video may be entire or partial fingerprint information of the video being played on the client terminal

Furthermore, the object information at the second step may include advertisement information set in correspondence with each object.

Furthermore, the object information at the second step may include address information indicative of a location of a web page on an Internet connected in correspondence with each object.

Furthermore, after the third step, if address information is selected, a web page corresponding to the address information may be provided to the client terminal.

Furthermore, after the third step, the client terminal may display the transmitted object information on a display device.

In accordance with yet another aspect of the present invention, the present invention provides an information provision system using video markup data based on video fingerprint information, the information provision system including a video markup database having video markup data generated by the above method and providing information while providing a video service to a client terminal connected over a network, including an object information query unit for receiving an object information request signal from the client terminal while providing a video playing service to the client terminal, and for querying the video markup database about object information in response to the object information request signal; and an object information transmission unit for transmitting the queried object information to the client terminal.

In accordance with still another aspect of the present invention, the present invention provides an information provision method using video markup data based on video fingerprint information, the information provision method providing information while providing a video service to a client terminal, in an information provision system including an information provision server provided with a video markup database having video markup data generated by the above method and a video service provision server connected to the client terminal over a network to provide the video service, the information provision method including a first step of the video service provision server receiving an object information request signal from the client terminal while providing a video playing service to the client terminal; a second step of the video service provision server requesting object information by transferring the object information request signal to the information provision server; a third step of the information provision server querying the video markup database about the object information in response to the object information request signal; and a fourth step of the information provision server transmitting the queried object information to the client terminal or to the video service provision server, and the video service provision server transmitting the received object information to the client terminal.

In this case, the object information request signal at the first step may be generated by a user selecting an object appearing on a video being played on a screen of a display device of the client terminal using an input device.

Further, the object information request signal may include information about a location selected by the user on the video being played on the screen of the display device of the client terminal, and the third step may be configured to query about the object information based on the location information included in the object information request signal.

Furthermore, the object information request signal may further include identification information of the video being played on the display device of the client terminal, and the third step may be configured to query about the object information based on the identification information of the video and the location information included in the object information request signal.

Furthermore, the identification information of the video may be entire or partial fingerprint information of the video being played on the client terminal

Furthermore, the object information at the third step may include advertisement information set in correspondence with each object.

Furthermore, the object information at the third step may include address information indicative of a location of a web page on an Internet connected in correspondence with each object.

Furthermore, after the fourth step, if address information is selected, a web page corresponding to the address information may be provided to the client terminal.

Furthermore, after the fourth step, the client terminal may display the transmitted object information on a display device.

In accordance with still another aspect of the present invention, the present invention provides an information provision system using video markup data based on video fingerprint information, the information provision system including an information provision server provided with a video markup database having video markup data generated by the above method and a video service provision server configured to provide a video service to a client terminal connected over a network, the information provision system providing information while providing the video service to the client terminal, wherein the video service provision server receives an object information request signal from the client terminal while providing a video playing service to the client terminal, transfers the received object information request signal to the information provision server, and transmits received object information to the client terminal if the object information is received from the information provision server, and the information provision server queries the video markup database about object information in response to the object information request signal received from the video service provision server, and transmits the queried object information to the video service provision server or to the client terminal

In accordance with still another aspect of the present invention, the present invention provides an information provision method using video markup data based on video fingerprint information, the information provision method providing information while providing a video service to a client terminal, in an information provision system including an information provision server provided with a video markup database having video markup data generated by the above method and a video service provision server connected to the client terminal over a network to provide the video service, the information provision method including a first step of the information provision server receiving an object information request signal from the client terminal while the video service provision server is providing a video playing service to the client terminal; a second step of the information provision server querying the video markup database about object information in response to the object information request signal; and a third step of the information provision server transmitting the queried object information to the client terminal.

In this case, the object information request signal at the first step may be generated by a user selecting an object appearing on a video being played on a screen of a display device of the client terminal using an input device.

Further, the object information request signal may include information about a location selected by the user on the video being played on the screen of the display device of the client terminal, and the second step may be configured to query about the object information based on the location information included in the object information request signal.

Furthermore, the object information request signal may further include identification information of the video being played on the display device of the client terminal, and the second step may be configured to query about the object information based on the identification information of the video and the location information included in the object information request signal.

Furthermore, the identification information of the video may be entire or partial fingerprint information of the video being played on the client terminal.

Furthermore, the object information at the second step may include advertisement information set in correspondence with each object.

Furthermore, the object information at the second step may include address information indicative of a location of a web page on an Internet connected in correspondence with each object.

Furthermore, after the third step, if address information is selected, a web page corresponding to the address information may be provided to the client terminal.

Furthermore, after the third step, the client terminal may display the transmitted object information on a display device.

In accordance with still another aspect of the present invention, the present invention provides an information provision system using video markup data based on video fingerprint information, the information provision system including an information provision server provided with a video markup database having video markup data generated by the above method and a video service provision server configured to provide a video service to a client terminal connected over a network, the information provision system providing information while providing the video service to the client terminal, wherein the information provision server receives an object information request signal from the client terminal while the video service provision server is providing a video playing service to the client terminal, queries the video markup database about object information in response to the object information request signal, and transmits the queried object information to the client terminal.

In accordance with still another aspect of the present invention, the present invention provides an information provision method using video markup data based on video fingerprint information, the information provision method providing information in a client terminal having video markup data generated by the above method, including a first step of receiving an object information request signal in response to a selection action of a user while providing a video playing service; a second step of querying the video markup data about object information in response to the object information request signal; and a third step of displaying the queried object information on a display device of the client terminal.

In this case, the object information request signal may include information about a location selected by the user on the video being played on the screen of the display device of the client terminal.

Further, the second step may be configured to query about the object information based on the location information included in the object information request signal.

Furthermore, the object information at the second step may include advertisement information set in correspondence with each object.

Furthermore, the object information at the second step may include address information indicative of a location of a web page on an Internet connected in correspondence with each object.

Furthermore, after the first step, playing of the video on the client terminal may be stopped, and may be resumed in response to a selection action on the client terminal.

In accordance with still another aspect of the present invention, the present invention provides a client terminal for providing information using video markup data based on video fingerprint information, the client terminal having video markup data generated by the above method, and providing information using the video markup data, including an object information processing unit for receiving an object information request signal in response to a selection action of a user while providing a video playing service, querying the video markup data about object information in response to the object information request signal, and displaying the queried object information on a display device of the client terminal.

### Advantageous Effects

In accordance with the present invention, there can be provided a method and apparatus that can generate video markup data from both the fingerprint information of a video and object information describing various meanings of landscapes, objects, and persons included in the video.

Further, in accordance with the present invention, there can be provided a method and system that cause additional information, such as advertisement information, to be included in object information included in the above video markup data, thus efficiently providing additional information, such as advertisement information set in correspondence with each object of a video, to users.

Furthermore, the present invention is advantageous in that it can provide a method and system that can generate video markup data, including unique fingerprint information, for a video, thus conveniently and efficiently providing the same object information or advertisement information even for various types of derivative video data obtained by processing or editing the corresponding video data.

Furthermore, the present invention can provide information about a specific area together with a link when a user expresses his or her interest in the specific area using a touch action based on the manipulation of a mouse on the specific area at a specific moment while the user is playing and viewing a video, and can accurately provide, in real time, ancillary information, such as advertisement information related to such an area.

Therefore, the user can obtain information about his or her target of interest while viewing video, without separately searching for the target information and can be exposed to advertisements, and thus this function makes it possible to exactly transfer the user's desired information without interfering with his or her video viewing experience, unlike the conventional video advertisements. Furthermore, the user may view video content bidirectionally without being limited to existing unidirectional information transfer.

### DESCRIPTION OF DRAWINGS

FIG. 1 is a diagram showing the configuration of an embodiment of a video markup data generation apparatus for generating video markup data based on video fingerprint to information according to the present invention;

FIG. 2 is a diagram showing an example of video markup data generated by a video markup data generation unit 13;

FIG. 3 is a flowchart showing an embodiment of a method of generating video markup data based on video fingerprint information, performed by the video markup data generation apparatus described with reference to FIGS. 1 and 2;

FIG. 4 is a flowchart showing a method of generating video markup data based on video fingerprint information according to another embodiment of the present invention;

FIG. 5 is a diagram showing an example of video markup data generated in the embodiment of FIG. 4;

FIG. 6 is a configuration diagram showing the configuration and connection state of an embodiment of an information provision system for providing information to a client terminal connected over a network by using the video markup data generated by the method and apparatus described with reference to FIGS. 1 to 5;

FIG. 7 is a flowchart showing an embodiment of an information provision method performed by an information provision system 20 and a client terminal 30 described in FIG. 6;

FIGS. 8 and 9 are a configuration diagram showing the configuration and connection state of another embodiment of an information provision system for providing information to a client terminal connected over a network by using video markup data generated by the method described with reference to FIGS. 1 to 5, and a flowchart, respectively;

FIG. 10 is a flowchart showing a method performed by an information provision system for providing information to a client terminal connected over a network by using video markup data generated by the method described with reference to FIGS. 1 to 5; and

FIG. 11 is a flowchart showing a further embodiment of a method of providing information in a client terminal using video markup data generated by the method and apparatus described with reference to FIGS. 1 to 5.

### BEST MODE

Hereinafter, embodiments of the present invention will be described in detail with reference to the attached drawings.

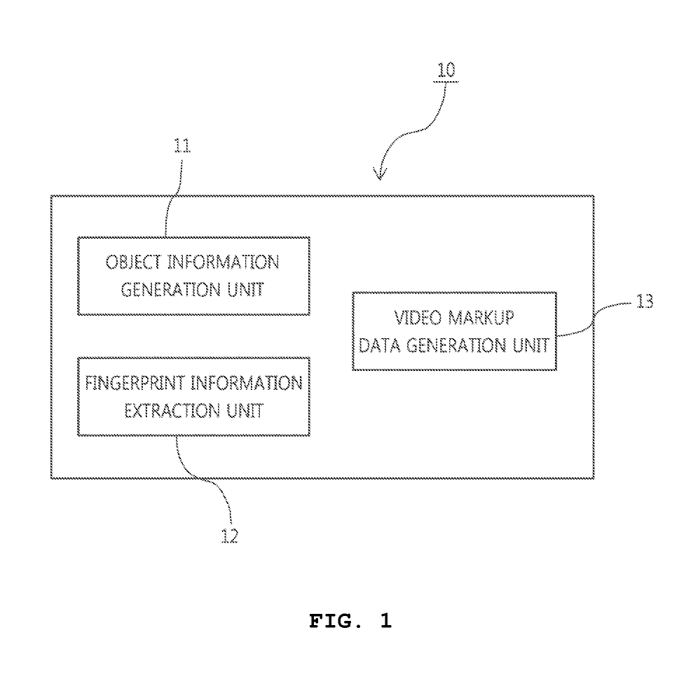

FIG. 1 is a diagram showing the configuration of an embodiment of a video markup data generation apparatus for generating video markup data based on video fingerprint information according to the present invention.

Referring to FIG. 1, a video markup data generation apparatus 10 includes an object information generation unit 11, a fingerprint information extraction unit 12, and a video markup data generation unit 13. The video markup data generation apparatus 10 generates, for one or more sections of video data, object information included in each of the sections, extracts partial fingerprint information corresponding to each section, and causes object information and partial fingerprint information to be included in each section, thus generating video markup data about the entire video data.

The object information generation unit 11 performs the function of generating, for one or more sections of video data that is a target for which video markup data is to be generated, object information about objects included in each of the sections.

Here, the term “objects” denotes persons, objects, landscapes, etc. appearing on a screen displayed on a display device when video data is played. Further, the term “object information” denotes information required to describe the features of these objects and may include one or more of pieces of information such as fade-in time information indicative of a time point at which each object appears, fade-out time information indicative of a time point at which each object disappears (is extinguished), and object space information including relative location information indicative of the location of each object and size information indicative of the size of the object on a display means when video data is played. Furthermore, the object information may be configured to include object feature information indicative of other features of each object, and advertisement information set in correspondence with each object.

Here, the term “advertisement information” denotes various types of multimedia content data, such as character-based text data, speech-based audio data, or video data composed of audio/video data.

Further, object information may also include connecting link information including address information indicative of the location of a web page on the Internet corresponding to each object. When the user selects an object appearing on the display means by means of an action, such as an action of clicking the object using a mouse based on the connecting link information, the user may go to a separate web page based on the connecting link information and purchase the corresponding object or provide other additional information.

The object information generation unit 11 is configured to, for one or more sections of the video data, generate the above-described object information about objects included in each of the sections. The generation of the object information may be performed by an input action of the user, and may also be configured such that object information is automatically generated in correspondence with each object using a video recognition method.

The fingerprint information extraction unit 12 functions to, for one or more sections of the video data, extract partial fingerprint information corresponding to each of the sections.

The term “fingerprint information” denotes feature data indicative of the features of the corresponding data, and is also referred to as “fingerprint data,” “DNA data” or “gene data.”

In relation to the fingerprint information, various schemes have been proposed according to the conventional technology, and it can be easily determined whether the identicalness of data is present if such fingerprint information is utilized, and thus such fingerprint information has recently been widely used in the field of Digital Rights Management (DRM) and the like. For example, in the case of audio data, fingerprint information may be generated using various types of feature data (e.g., frequency, amplitude, etc.) indicative of the features of audio data, and in the case of video data, fingerprint information may be generated using various types of feature data related to the video data (e.g., the motion vector information, color information, etc. of each frame).

An object of the present invention is not a method itself of generating such fingerprint information, and any type of conventional fingerprint generation/extraction method can be used without change, and thus a detailed description thereof will be omitted here.

In accordance with Korean Patent Application No. 10-2007-0044251 (entitled “Method and apparatus for generating audio fingerprint data and method and apparatus for comparing audio data using the same”), Korean Patent Application No. 10-2007-0054601 (entitled “Method and apparatus for determining identicalness of video data and detecting an identical section”), Korean Patent Application No. 10-2007-0060978 (entitled “Method and system for clustering pieces of video data having identicalness among pieces of video data”), Korean Patent Application No. 10-2007-0071633 (entitled “Method and apparatus for providing a video data search service using video data clusters”), Korean Patent Application No. 10-2007-0091587 (entitled “Method and apparatus for setting and providing advertisement data using video data clusters”), and Korean Patent Application No. 10-2008-0051688 (entitled “Video processing method and apparatus”), which are filed by the present applicant, methods of generating the fingerprint data of audio or video data and clustering methods using such fingerprint data are described, and it is apparent that the fingerprint (DNA) generation and extraction methods, filed by the present applicant, can also be applied to the present invention. In summary, the present invention can use conventional well-known fingerprint generation/extraction technology for video data without any changes, regardless of which type of fingerprint information extraction scheme has been used, and it is meaningful, in relation to the present invention, in that, for a predetermined number of sections of the video data, partial fingerprint information related to each section is extracted.

Partial fingerprint information related to each section may be extracted based on object information. As described above, object information may include fade-in time information indicative of a time point at which an object appears, fade-out time information indicative of a time point at which an object disappears (is extinguished), etc. For example, partial fingerprint information corresponding to a section ranging from the fade-in time of the object to a predetermined time (for example, 1 minute) may be extracted. Further, partial fingerprint information corresponding to a section ranging from a predetermination time (for example, 1 minute before) to the fade-out time of the object may also be extracted. Furthermore, it is apparent that the partial fingerprint information corresponding to the section of 1 minute after the object fade-in time, and the partial fingerprint information corresponding to the section of 1 minute before the object fade-out time may be used together.

In this way, the extraction of partial fingerprint information for the corresponding section is required so as to subsequently search the corresponding section with high distinction ability. Accordingly, as a time interval required to extract partial fingerprint information is lengthened, distinction ability is improved, but the amount of data may be increased, whereas as the time interval is shortened, the amount of data is decreased, but the distinction ability may be deteriorated. As a result, there is a need to set a suitable time interval within an appropriate range.

As described above, the video markup data generation unit 13 functions to generate video markup data for each section by including the object information generated by the object information generation unit 11 and the partial fingerprint information for each section generated by the fingerprint extraction unit 12.

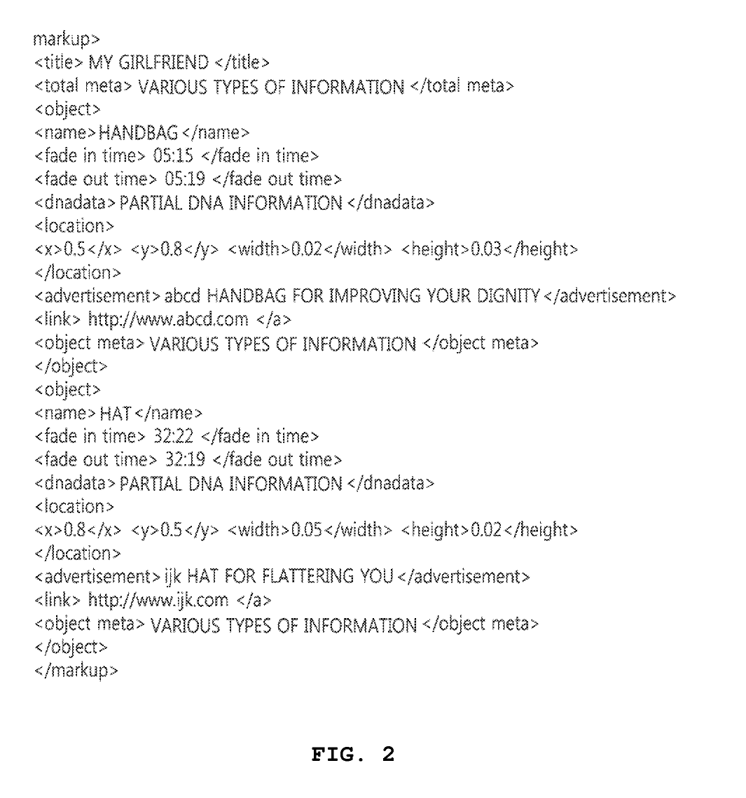

FIG. 2 is a diagram showing an example of video markup data generated by the video markup data generation unit 13.

Referring to FIG. 2, the title of the corresponding video data is included in <title>, and metadata including various types of description data related to the entire video data is included in <total meta>.

Object information is defined in <object>˜</object>, and it can be seen that a first object relates to an object ‘handbag.’ Also, it can be seen that the fade-in time information of this ‘handbag’ is 5 minutes 15 seconds, and fade-out time information is 5 minutes 18 seconds. Below the fade-out time, partial fingerprint information related to the corresponding section is included in <dnadata> in the form of, for example, a binary number.

Next, in <location>, object space information, such as relative location information indicative of the location of each object and size information indicative of the size of the object on the display means when video data is played, is defined.

Next, in <advertisement>, advertisement information, such as “abcd handbag for improving your dignity” configured in the form of text, is included as advertisement information set in correspondence with the corresponding object. Further, it can be seen that in <link>, “http://www.abcd.com” is included as connecting link information that is address information indicative of the location of a web page over the Internet corresponding to the object. Furthermore, it is possible to add other various types of information related to the corresponding object and represent them in <object meta>.

A second object is related to a ‘hat’, and it can be seen that the above-described various types of object information and partial fingerprint information, together with the fade-in time information and the fade-out time information of the object, are included.

In FIG. 2, for the sake of convenience of description, a description has been made on the assumption that two objects are present, but, in the case of the entire video data, object information and partial fingerprint information are generated for each object and for each of a plurality of sections corresponding to times at which objects appear and disappear, as shown in FIG. 2, thus enabling video markup data to be generated for the entire video data.

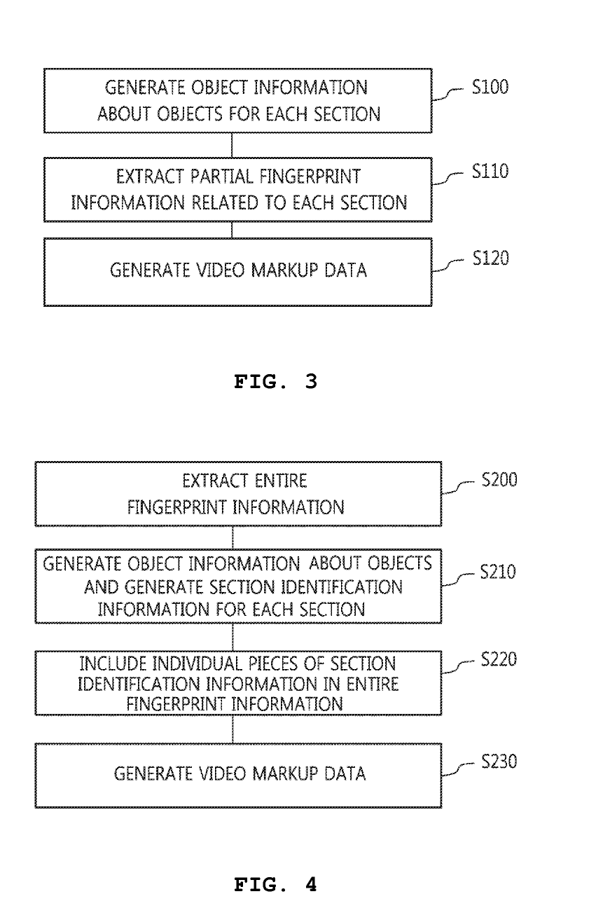

FIG. 3 is a flowchart showing an embodiment of a method of generating video markup data based on video fingerprint information performed by the video markup data generation apparatus described with reference to FIGS. 1 and 2.

Referring to FIG. 3, the object information generation unit 11 generates, for one or more sections of video data that is a target for which video markup data is to be generated, object information about objects included in each of the sections (S100). Here, as described above, the object information may include at least one of the fade-in time information of each object and the fade-out time information of the object. Further, the object information may include object space information indicative of relative location information and size information on a display means when video data is played, object feature information indicative of the features of each object, and advertisement information set in correspondence with each object. Furthermore, the object information may also include address information indicative of the location of a web page over the Internet set in correspondence with each object.

Next, for each of the sections, the fingerprint information extraction unit 12 extracts partial fingerprint information related to the section (S110). As described above, the extraction of partial fingerprint information may be performed to extract the partial fingerprint information based on time intervals based on the fade-in time information and/or the fade-out time information of each object included in the object information.

As described above, when the extraction of object information and partial fingerprint information has been completed, the video markup data generation unit 13 generates video markup data about the video data so that each section includes object information and partial fingerprint information, as shown in FIG. 2 (S120).

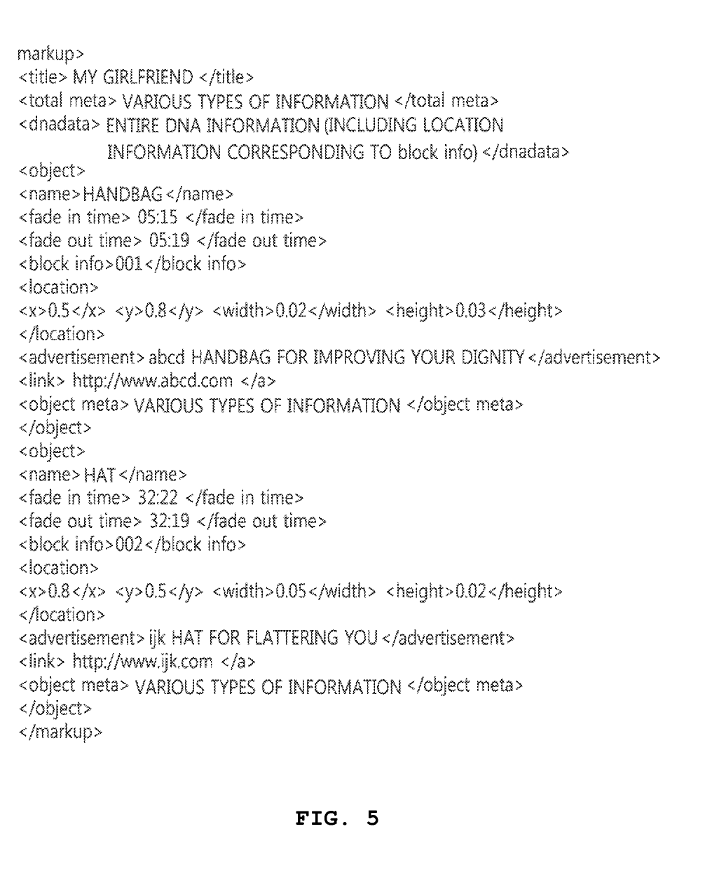

FIG. 4 is a flowchart showing a method of generating video markup data based on video fingerprint according to another embodiment of the present invention. The embodiment of FIG. 4 is basically common to the above embodiment described with reference to FIGS. 1 to 3, but there is a difference in that the entire fingerprint information about the entire video data is generated without partial fingerprint information being extracted for each section, and section identification information for each section including objects is included in the entire fingerprint information to be identifiable.

Referring to FIG. 4, the entire fingerprint information corresponding to the entire section of video data is extracted (S200). Here, the extraction of the entire fingerprint information is performed to extract pieces of fingerprint information so that they correspond to pieces of time information of the video data, and to generate the pieces of fingerprint information so that they matches the respective pieces of time information.

For example, the entire time period is divided into intervals of 1 second, and pieces of fingerprint information at respective time points are separately extracted and generated for the entire time period, like fingerprint information at 1 second, fingerprint information at 2 seconds, . . . , etc. In this case, as described above, the pieces of fingerprint information at respective time points are preferably configured to extract fingerprint information for each time interval of a predetermined range including the corresponding time point so that the respective pieces of fingerprint information can be distinguished from each other. For example, it is preferable to configure fingerprint information at 1 second as fingerprint information extracted for an interval ranging from 1 second to 10 seconds, and configure fingerprint information at 2 seconds as fingerprint information extracted for an interval ranging from 2 seconds to 11 seconds.

Next, for one or more sections of video data that is a target for which video markup data is to be generated, section identification information for each of the sections and object information about objects included in each section are generated (S210). Here, the generation of the object information is performed in the same manner as described with reference to FIGS. 1 to 3, and thus a detailed description thereof is omitted.

Here, the term “section identification information” denotes information required to identify a location where each section is placed in the entire video data, and denotes section time information about the corresponding section in the total time of the entire video data. This may be designated by, for example, both the object fade-in time information and the object fade-out time information included in the object information described with reference to FIGS. 1 to 3.

Next, individual pieces of section identification information are included in the entire fingerprint information to be identifiable (S220). This step is intended to include pieces of section identification information related to respective sections in the entire fingerprint information generated in correspondence with the time information at step S200 so that the pieces of section identification information are identifiable, and denotes that each section is marked with reference to the time information of the entire fingerprint information. In this way, locations where the respective sections are placed in the entire fingerprint information can be determined.

Then, video markup data about the video data is generated so that it includes the entire fingerprint information, pieces of section identification information for respective sections, and pieces of object information for respective sections (S230). This is performed in the same manner as shown in FIG. 2, but there is a difference in that, as described above, the entire fingerprint information is included in the video markup data, and so partial fingerprint information is not required, and the pieces of section identification information are included in the video markup data.

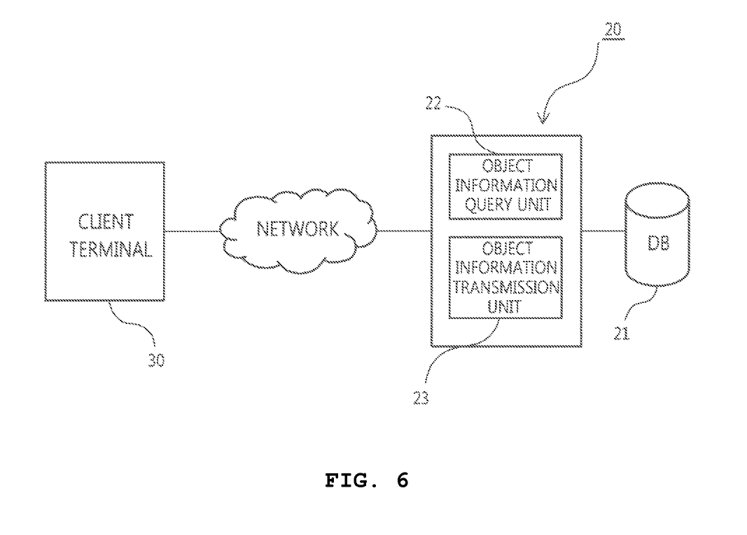

FIG. 5 is a diagram showing an example of video markup data generated in the embodiment of FIG. 4.

It can be seen that, compared to FIG. 2, FIG. 5 shows that partial fingerprint information for each object is omitted, the entire fingerprint information is included in video markup data, and section identification information is included in information for each object by <block info>. In the case of FIG. 5, the entire fingerprint information includes location information allowing section identification information based on <block info> to refer to the corresponding location. This is possible because the entire fingerprint information is extracted in correspondence with individual times, as described above.

Meanwhile, the embodiments shown in FIGS. 4 and 5 may be implemented by the apparatus described above with reference to FIG. 1, without change. However, there is a difference in that the fingerprint information extraction unit 12 of FIG. 1 extracts entire fingerprint information about the entire video data rather than extracting partial fingerprint information. Further, there is an additional difference in that the object information generation unit 11 generates object information to include section identification information for a section to which each object belongs, and the section identification information is included in the entire fingerprint information. Other components are identical to those of FIG. 1, and thus a detailed description thereof is omitted.

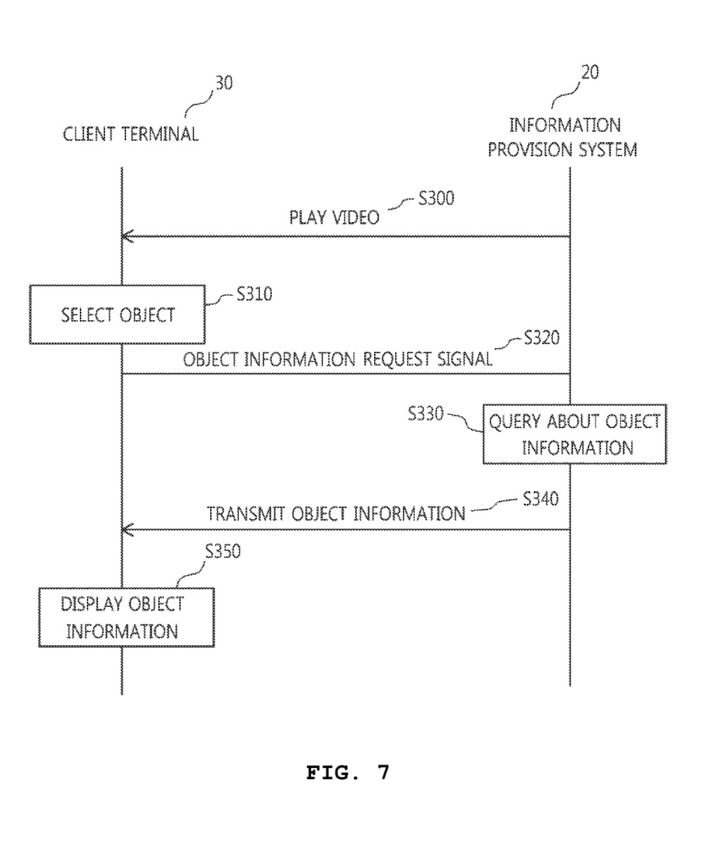

FIG. 6 is a configuration diagram showing the configuration and connection state of an embodiment of an information provision system for providing information to a client terminal connected over a network by using the video markup data generated by the method and apparatus described with reference to FIGS. 1 to 5.

Referring to FIG. 6, an information provision system 20 comprises a video markup database (DB) 21 having video markup data and the system 20 is connected to a client terminal 30 over the network and is configured to provide information to the client terminal 30.

In this case, the video markup DB 21 stores video markup data, generated by the method described with reference to FIGS. 1 to 5, in correspondence with each piece of video data. Further, in addition to the above data, the video markup DB 21 may store all required additional data and information, such as user information, which are related to the provision of video and the provision of information. The video markup DB 21 may configure video markup data in advance for each of all pieces of video data provided by the information provision system 20 using the method identical to that described with reference to FIGS. 1 to 5, and may store the configured video markup data.

Further, the information provision system 20 includes an object information query unit 22 and an object information transmission unit 23. The object information query unit 22 functions to receive an object information request signal from the client terminal 30 while providing a video playing service to the client terminal 30, and to query the video markup DB 21 about object information in response to the received object information request signal. The object information transmission unit 23 functions to transmit the object information retrieved by the object information query unit 22 to the client terminal 30. Meanwhile, the information provision system 20 may include a video markup data generation apparatus (not shown) described above with reference to FIGS. 1 to 5.

The client terminal 30 is connected to the information provision system 20 over a network, such as the Internet or a mobile communication network. The client terminal 30 may be a device, for example, a computer, a mobile communication terminal, a Personal Digital Assistant (PDA), or the like. The client terminal 30 is connected to the information provision system 20 over the network, and is configured to generate an object information request signal by performing a selection action, such as by clicking an object of interest on a video being played on the screen of a display device using an input device such as a mouse, while the video provided by the information provision system 20 is being played and viewed. The generated object information request signal is transmitted to the information provision system 30 over the network. At this time, that is, at a time point at which the user selects the object, the operation of playing the video may be stopped.

The object information request signal may include information about a location selected by the user on the video being played on the screen of the display device of the client terminal For example, (x, y) coordinate values of the location selected by the user on the screen displayed on the display device may be set to the location information. The (x, y) coordinate values at this time denote relative coordinate values on the screen on which the video is being played, other than absolute coordinate values on the entire display device.

In addition, the object information request signal may further include identification information of video played on the display device of the client terminal. Here, the identification information of video may be, for example, the title information, file name, etc. of the video. Of course, since the information provision system 20 may previously recognize video being provided to the client terminal 30, the identification information of video is not always necessary.

Meanwhile, the entire or partial fingerprint information of a video being played on the client terminal may also be used as the identification information of the video. Here, the term “entire or partial fingerprint information” denotes such entire or partial fingerprint information as described with reference to FIGS. 1 to 5.

For example, when the user selects a specific object at a specific time point using the action of clicking the mouse, it is possible to extract partial fingerprint information corresponding to a predetermined time interval (for example, 10 seconds) ranging from the selection time point, and include the partial fingerprint information in the object information request signal.

Further, when the user selects a specific object, it is possible to extract the entire fingerprint information of the corresponding video data, and include the entire fingerprint information in the object information request signal. This configuration is required to more accurately determine information about the video and the object selected by the user in the information provision system 30, but may be omitted depending on the circumstances.

In this way, when the object information request signal is generated by the client terminal 30 and is transmitted from the client terminal 30 to the information provision system 20 over the network, the object information query unit 22 of the information provision system 20 may query the video markup DB 21 about object information in response to the received object information request signal.

In this case, since the object information query unit 22 recognizes which a video is being played on the client terminal 30, it reads video markup data corresponding to the identification information (e.g., file name) of the video from the video markup DB 21, checks object information stored in correspondence with the object selected by the user, based on the location information included in the object information request signal, and transmits the object information to the client terminal 30 through the object information transmission unit 23.

As described with reference to FIGS. 2 and 5, the video markup data stores object information about objects for each section of one piece of video data, and thus the location information is used to identify the corresponding object. Of course, in order to more accurately identify object information, time information about the time point at which the user selected the object on the client terminal 30 may also be used together. In this case, the object information request signal may further include such time information. However, in a case where only time information is used, location information must be used to exactly identify the object selected by the user because various types of objects may be included on the screen being played in the same time span.

Meanwhile, in a case where the identification information of video is included in the object information request signal and such identification information must be used, the object information query unit 22 queries the video markup DB 21 about the corresponding video markup data using the identification information of the video, and then checks the object information based on the video markup data. Of course, even in this case, the object information is checked either based on location information or based on location information and time information.

If the object information has been queried and checked in this way, the information provision system 20 transmits the queried object information to the client terminal 30 through the object information transmission unit 23.

Meanwhile, as described above with reference to FIGS. 1 to 5, the object information may include the name, fade-in time information, fade-out time information, location information, advertisement information, and connecting link information of the corresponding object, and other metadata. There is no need to transmit all of the pieces of information to the client terminal 30, and it is preferable to transmit only some information if necessary. For example, since the user will not be greatly interested in fade-in time information, fade-out time information, and location information, it is preferable to transmit only the name, advertisement information, and connecting link information of the object, and other metadata describing the features of the object.

When the object information is transmitted from the information provision system 20, the client terminal 30 processes the object information in a format suitable for displaying on the display device, and displays the processed object information on the display device.

In this way, when the object information is displayed on the display device of the client terminal 30, the user may check object information displayed on the display device and may then be provided with information related to his or her object of interest in real time. In this case, when an external connecting link is included in the object information, such external connecting link information contains the address information of a linked web page, and thus the corresponding web page is provided to the display device of the client terminal when the user selects the connecting link information.

Preferably, the corresponding web page may be a web page related to the object. For example, when the object is “hat,” the external connecting link information may be generated so that web pages, such as an electronic commerce site where the corresponding hat is sold, a manufacturer site for the hat, and a price comparison site related to the hat, can be provided.

Next, in response to a selection action such as by the user re-pressing a play button using a mouse on the client terminal 30, the playing of video that was stopped may be resumed.

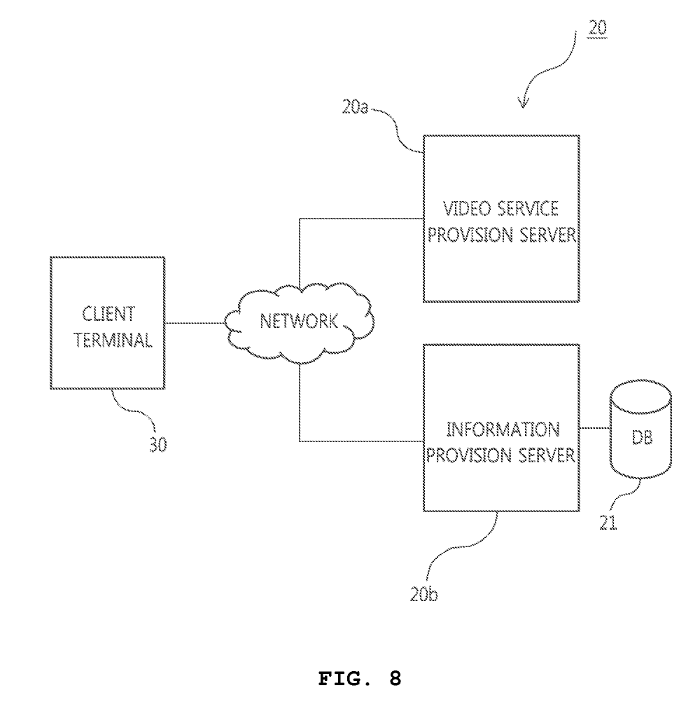

FIG. 7 is a flowchart showing an embodiment of an information provision method performed by the information provision system 20 and the client terminal 30 described with reference to FIG. 6.

Referring to FIG. 7, the client terminal 30 receives video from the information provision system 20, and selects an object of interest at a specific time point (S310) while playing the video (while the video is being viewed) (S300). In this case, the selection of the object may be performed in such a way as to click an object appearing on the screen using a mouse or the like, as described above.

When the user selects the object, the client terminal 30 represents information about a location where the selection action is performed, that is, relative location information on the play screen, by (x, y) coordinate values, includes the coordinate coordinates in an object information request signal, and transmits a resulting object information request signal to the information provision system 20 (S320). In this case, the object information request signal may include the identification information of video, or time information about a time point at which the user performs the selection action, as described above.

When the object information request signal is received, the information provision system 20 reads video markup data from the video markup DB 21 by referring to the location information, time information, and identification information included in the object information request signal, and queries about and checks object information corresponding to the object (S330).

Further, as described with reference to FIG. 6, the queried and checked object information is transmitted to the client terminal 30 (S340), and the client terminal 30 processes the received object information in a form suitable for displaying on the display device, and displays the processed information on the display device (S350).

Thereafter, as described with reference to FIG. 6, when the user of the client terminal 30 selects external connecting link information included in the object information, the corresponding web page is provided to the client terminal 30, and if the user performs a selection action to resume the playing of the video, the playing of the video that was stopped is resumed.

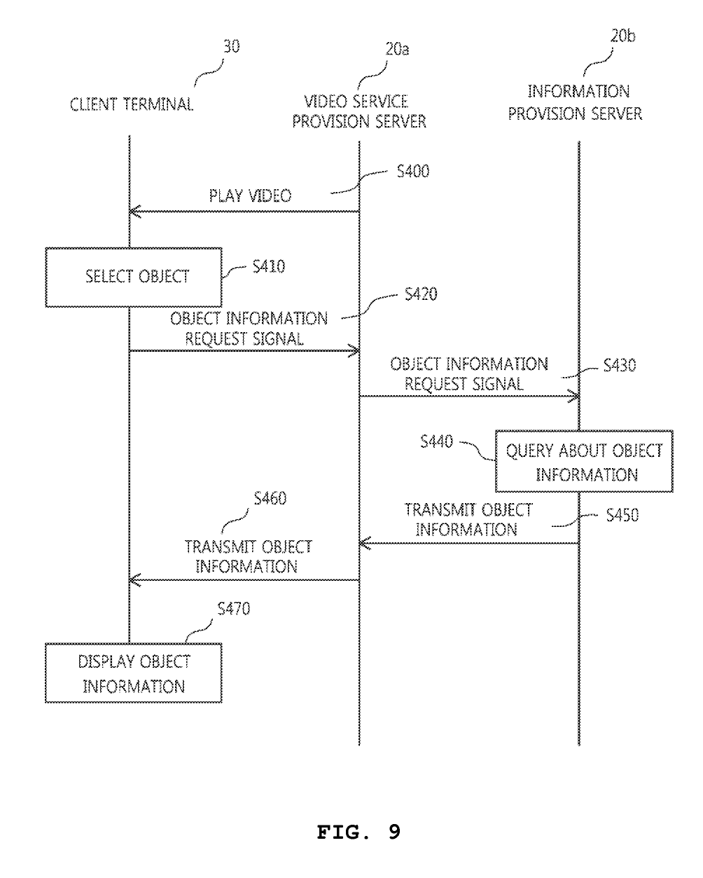

FIGS. 8 and 9 are a configuration diagram showing the configuration and connection state of another embodiment of an information provision system for providing information to a client terminal connected over a network by using video markup data generated by the method described with reference to FIGS. 1 to 5, and a flowchart showing another embodiment of an information provision method performed by the information provision system.

Compared to the embodiments described with reference to FIGS. 6 and 7, the embodiments of FIGS. 8 and 9 have a difference in that an information provision system 20 is configured to be separated into a video service provision server 20a and an information provision server 20b, and is characterized in that a client terminal 30 receives object information from the information provision server 20b via the video service provision server 20a if an object information request signal is generated while receiving a video playing service from the video service provision server 20a.

Referring to FIGS. 8 and 9, the video service provision server 20a provides a video playing service to the client terminal (S400). During the provision of the video playing service, when the client terminal 30 selects an object of interest from the played video (S410), an object information request signal is generated and transmitted to the video service provision server 20a, in the above-described manner (S420).

The video service provision server 20a requests object information by transferring the received object information request signal to the information provision server 20b (S430), and the information provision server 20b queries the video markup DB 21 about the object information in response to the received object information request signal (S440), and sends the queried object information to the video service provision server 20a (S450).

The video service provision server 20a transmits the received object information to the client terminal 30 (S460), and the client terminal 30 displays the received object information (S470). Here, the information provision server 20b may directly transmit the object information to the client terminal 30 instead of transmitting it to the video service provision server 20a. For this operation, the video service provision server 20a preferably transmits information, such as the Internet Protocol (IP) address of the client terminal 30, when transmitting the object information request signal to the information provision server 20b.

Meanwhile, the configurations and operations of the embodiments of FIGS. 8 and 9, except for the above-described differences, are identical to those described with reference to FIGS. 6 and 7, and thus a detailed description thereof will be omitted.

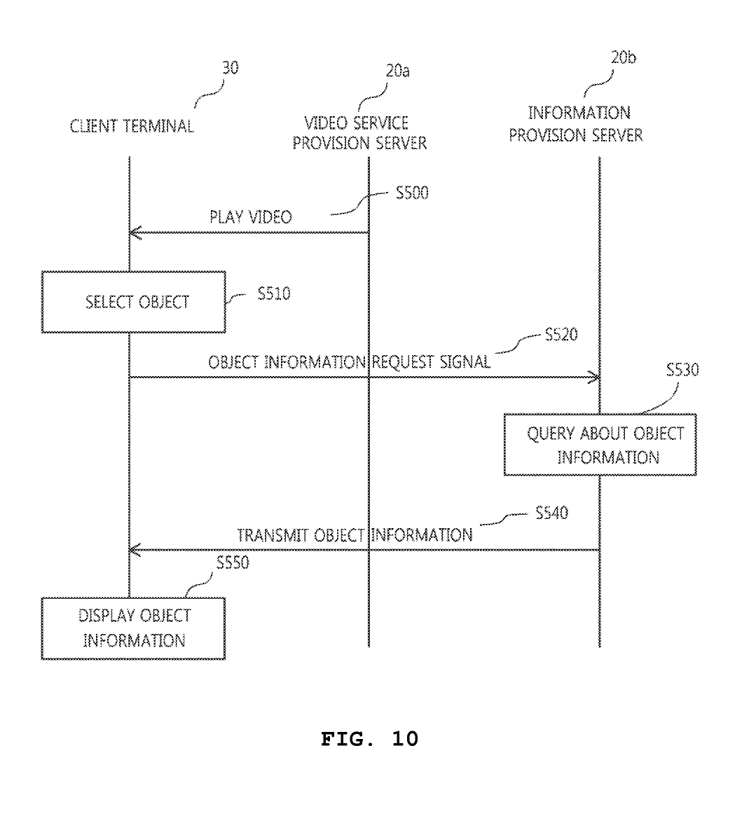

FIG. 10 is a flowchart showing a further embodiment of an information provision method of providing information to a client terminal connected over a network using the video markup data generated by the method described with reference to FIGS. 1 to 5.

Compared to the embodiment of FIG. 9, the embodiment of FIG. 10 is identical in that a video service provision server 20a and an information provision server 20b are separately configured, as shown in FIG. 8, but there is a difference in that an object information request signal generated by the client terminal 30 is transmitted to the information provision server 20b without passing through the video service provision server 20a, and in that the information provision server 20b directly transmits queried object information to the client terminal 30 without passing through the video service provision server 20a.

Referring to FIG. 10, the video service provision server 20a provides a video playing service to the client terminal (S500). If, during the provision of the video playing service, the client terminal 30 selects an object of interest from the played video (S510), an object information request signal is generated and transmitted to the information provision server 20b in the above-described manner (S520).

The information provision server 20b queries the video markup DB 21 about object information in response to the received object information request signal (S530), and transmits the queried object information to the client terminal 30 (S540). Next, the client terminal 30 displays the received object information (S550). The present embodiment is characterized in that the video service provision server 20a merely provides a video service and in that the transmission of the object information request signal and the object information is directly performed between the client terminal 30 and the information provision server 20b.

Meanwhile, the configurations and operations of the embodiment of FIG. 10, except for the above-described differences, are identical to those described with reference to FIGS. 6 to 9, and thus a detailed description thereof will be omitted.

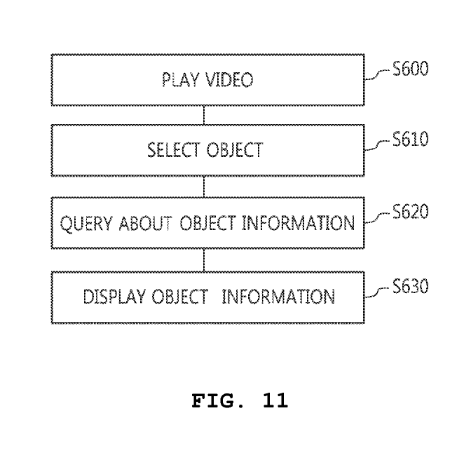

FIG. 11 is a flowchart showing a further embodiment of a method of providing information in a client terminal using the video markup data generated by the method and apparatus described with reference to FIGS. 1 to 5.

The embodiment of FIG. 11 is basically identical to the information provision method and system described with reference to FIGS. 6 and 7, but there is a difference in that video data and video markup data are stored in the client terminal and then the configuration of an information provision system is not required.

Referring to FIG. 11, when the user selects an object (S610) while the client terminal 30 is playing video data stored therein (S600), the client terminal 30 queries about object information corresponding to the object (S620). Next, if the object information has been queried about, the object information is displayed on the display device (S630). This procedure is identical to that of FIGS. 6 and 7, except that the video data is stored in the client terminal 30 and video markup data required to query about the object information is stored in the client terminal 30, and thus a detailed description thereof will be omitted.

1. A method of generating video markup data based on video fingerprint information, comprising:
a first step of generating, for one or more sections of video data being a target for which video markup data is to be generated, object information about objects included in each of the sections;
a second step of extracting, for the sections, partial fingerprint information related to each of the sections; and
a third step of generating video markup data about the video data so that the object information and the partial fingerprint information are included in each section.

2. The method of claim 1, wherein:
the object information at the first step includes at least one of fade-in time information and fade-out time information of each object, and
the partial fingerprint information at the second step is extracted based on at least one of the fade-in time information and the fade-out time information of the object.

3. The method of claim 1, wherein the object information at the first step includes object space information indicative of relative location information and size information on display means when the corresponding video data is played, object feature information indicative of features of each object, and advertisement information set in correspondence with each object.

4. A method of generating video markup data based on video fingerprint information, comprising:
a first step of extracting, for all sections of video data, entire fingerprint information;
a second step of generating, for one or more sections of video data being a target for which video markup data is to be generated, section identification information for each of the sections and object information about objects included in each section;
a third step of including individual pieces of section identification information in the entire fingerprint information so that the pieces of section identification information are identifiable; and
a fourth step of generating video markup data about the video data so that the video markup data includes the entire fingerprint information, the section identification for each section, and the object information for each section.

5. The method of claim 4, wherein the object information at the second step includes at least one of fade-in time information and fade-out time information of each object.

6. The method of claim 4, wherein the object information at the second step includes object space information indicative of relative location information and size information on display means when the corresponding video data is played, object feature information indicative of features of each object, and advertisement information set in correspondence with each object.

7. A method for providing information while providing a video service to a client terminal, in an information provision system comprising a video markup database having video markup data generated by the method set forth in claim 1 and connected to the client terminal over a network, the method comprising:
a first step of receiving an object information request signal from the client terminal while providing a video playing service to the client terminal;
a second step of querying the video markup database about object information in response to the object information request signal; and
a third step of transmitting the queried object information to the client terminal.

8. The method of claim 7, wherein:
the object information request signal at the first step is generated by a user selecting an object appearing on a video being played on a screen of a display device of the client terminal using an input device,
the object information request signal includes information about a location selected by the user on the video being played on the screen of the display device of the client terminal, and
the second step is configured to query about the object information based on the location information included in the object information request signal.

9. (canceled)

10. The method of claim 8, wherein:
the object information request signal further includes identification information of the video being played on the display device of the client terminal,
the second step is configured to query about the object information based on the identification information of the video and the location information included in the object information request signal,
the identification information of the video is entire or partial fingerprint information of the video being played on the client terminal.

11. (canceled)

12. The method of claim 7, wherein the object information at the second step includes advertisement information set in correspondence with each object, and
the object information at the second step includes address information indicative of a location of a web page on an Internet connected in correspondence with each object.

13. (canceled)

14. The method of claim 7, wherein, after the third step, if address information is selected, a web page corresponding to the address information is provided to the client terminal.

15. The method of claim 7, wherein, after the third step, the client terminal displays the transmitted object information on a display device.

16. An information provision system for providing information while providing a video service to a client terminal connected over a network, and the information provision system including a video markup database having video markup data generated by the method set forth in claim 1, and the information provision system comprising:
an object information query unit for receiving an object information request signal from the client terminal while providing a video playing service to the client terminal, and for querying the video markup database about object information in response to the object information request signal; and
an object information transmission unit for transmitting the queried object information to the client terminal.

17. A method for providing information while providing a video service to a client terminal, in an information provision system including an information provision server comprising a video markup database having video markup data generated by the method set forth in claim 1 and a video service provision server connected to the client terminal over a network for providing the video service, the method comprising:
a first step of the video service provision server receiving an object information request signal from the client terminal while providing a video playing service to the client terminal;
a second step of the video service provision server requesting object information by transferring the object information request signal to the information provision server;
a third step of the information provision server querying the video markup database about the object information in response to the object information request signal; and
a fourth step of the information provision server transmitting the queried object information to the client terminal or to the video service provision server, and the video service provision server transmitting the received object information to the client terminal.

18. (canceled)

19. (canceled)

20. (canceled)

21. (canceled)

22. (canceled)

23. (canceled)

24. (canceled)

25. (canceled)

26. An information provision system for providing information while providing the video service to the client terminal, the information provision system including an information provision server provided with a video markup database having video markup data generated by the method set forth in claim 1 and a video service provision server configured for providing a video service to a client terminal connected over a network, wherein:
the video service provision server receives an object information request signal from the client terminal while providing a video playing service to the client terminal, transfers the received object information request signal to the information provision server, and transmits received object information to the client terminal if the object information is received from the information provision server, and
the information provision server queries the video markup database about object information in response to the object information request signal received from the video service provision server, and transmits the queried object information to the video service provision server or to the client terminal.

27. A method for providing information while providing a video service to a client terminal, in an information provision system including an information provision server provided with a video markup database having video markup data generated by the method set forth in claim 1 and a video service provision server connected to the client terminal over a network for providing the video service, the method comprising:
a first step of the information provision server receiving an object information request signal from the client terminal while the video service provision server is providing a video playing service to the client terminal;
a second step of the information provision server querying the video markup database about object information in response to the object information request signal; and
a third step of the information provision server transmitting the queried object information to the client terminal.

28. (canceled)

29. (canceled)

30. (canceled)

31. (canceled)

32. (canceled)

33. (canceled)

34. (canceled)

35. (canceled)

36. An information provision system for providing information while providing the video service to the client terminal, the information provision system including an information provision server provided with a video markup database having video markup data generated by the method set forth in claim 1 and a video service provision server configured for providing a video service to a client terminal connected over a network, wherein:
the information provision server receives an object information request signal from the client terminal while the video service provision server is providing a video playing service to the client terminal, queries the video markup database about object information in response to the object information request signal, and transmits the queried object information to the client terminal.

37. A method for providing information in a client terminal having video markup data generated by the method set forth in claim 1, comprising:
a first step of receiving an object information request signal in response to a selection action of a user while providing a video playing service;
a second step of querying the video markup data about object information in response to the object information request signal; and
a third step of displaying the queried object information on a display device of the client terminal.

38. (canceled)

39. (canceled)

40. (canceled)

41. (canceled)

42. (canceled)

43. A client terminal for providing information using the video markup data, the client terminal having video markup data generated by the method set forth in claim 1, comprising:
an object information processing unit for receiving an object information request signal in response to a selection action of a user while providing a video playing service, querying the video markup data about object information in response to the object information request signal, and displaying the queried object information on a display device of the client terminal.
